(19) United States
(12) Patent Application Publication
(10) Pub. No.: US 2015/0317156 A1
(43) Pub. Date: Nov. 5, 2015

(54) Systems and Methods for Automated Generation of Interactive Documentation Based on Web Application Description Language Files

(71) Applicant: CA, INC., Islandia, NY (US)

(72) Inventors: Vincent Wing-Chiu Chan, Burnaby (CA); Dana Mark Crane, Vancouver (CA); Richard Jason Raquepo, Burnaby (CA); John Bagtas, Richmond (CA)

(73) Assignee: CA, INC., Islandia, NY (US)

(21) Appl. No.: 14/267,258

(22) Filed: May 1, 2014

(51) Int. Cl. G06F 9/44

(52) U.S. Cl. CPC G06F 8/73

(57) ABSTRACT

In a method of generating documentation for a computing interface, an interface description file that includes a machine-readable description of a computing interface is parsed. Elements of the interface description file are identified according to a template file responsive to the parsing thereof, and an output file that includes human-readable documentation for the computing interface is automatically generated from the elements identified in the interface description file. Related devices and computer program products are also discussed.

### BACKGROUND

Various embodiments described herein relate to computing systems, and more specifically, to computing systems that provide web applications.

An increasing number of web-based applications may include HTTP-based applications that provide programmatic access to their internal data. Typically these applications are described using textual documentation that is sometimes supplemented with more formal specifications (such as XML schema for XML-based data formats).

An owner of an Application Program Interface (API) for a web-based application may desire to ease a developer's efforts to create software (for example, for mobile devices) that access the owner's application via the API, for example, by publishing documentation for the API. While the software or source code implementing the API may include embedded comments that can be used to generate such documentation, such comments are typically provided by a programmer, and thus, may be difficult to understand or otherwise less meaningful to a developer. Such documentation may be thus subject to misinterpretation, as well as to version skew issues (e.g., where the API changes but the embedded comments are not changed accordingly).

### BRIEF SUMMARY

Systems, methods, and computer program products for automatically generating documentation for a computing interface are disclosed.

According to an embodiment described herein, in a method of generating documentation for a computing interface, an interface description file that includes a machine-readable description of a computing interface is parsed. Elements of the interface description file are identified according to a template file responsive to the parsing thereof, and an output file that includes human-readable documentation for the computing interface is automatically generated from the elements identified in the interface description file. The parsing, the identifying, and the automatically generating are performed by at least one processor.

According to an embodiment described herein, a computer system for generating documentation for a computing interface includes a processor and a memory coupled to the processor. The memory includes computer readable program code embodied therein that, when executed by the processor, causes the processor to parse an interface description file that includes a machine-readable description of a computing interface, identify elements of the interface description file according to a template file, and automatically generate an output file that includes human-readable documentation for the computing interface from the elements identified in the interface description file.

According to an embodiment described herein, a computer program product for generating documentation for a computing interface includes a computer readable storage medium having computer readable program code embodied in the medium. The computer readable program code includes computer readable code to parse an interface description file that includes a machine-readable description of a computing interface, computer readable program code to identify elements of the interface description file according to a template file, and computer readable program code to automatically generate an output file that includes human-readable documentation for the computing interface from the elements identified in the interface description file.

It is noted that aspects described with respect to one embodiment may be incorporated in different embodiments although not specifically described relative thereto. That is, all embodiments and/or features of any embodiments can be combined in any way and/or combination. Moreover, other systems, methods, and/or computer program products according to embodiments will be or become apparent to one with skill in the art upon review of the following drawings and detailed description. It is intended that all such additional systems, methods, and/or computer program products be included within this description, be within the scope of the present disclosure, and be protected by the accompanying claims.

### BRIEF DESCRIPTION OF THE DRAWINGS

Aspects of the present disclosure are illustrated by way of example and are not limited by the accompanying figures with like references indicating like elements.

FIG. 1 is a block diagram of a computing system or environment for automatically generating documentation for a computing interface in accordance with some embodiments of the present disclosure.

FIG. 2 is a block diagram illustrating automatic generation of documentation for a computing interface in accordance with some embodiments of the present disclosure.

FIG. 3 is a block diagram that illustrates a computing device for automatically generating documentation for a computing interface in accordance with some embodiments of the present disclosure

FIG. 4 is a block diagram that illustrates a hardware/software architecture for automatically generating documentation for a computing interface in accordance with some embodiments of the present disclosure.

FIGS. 5 and 6 are flowcharts that illustrate operations for automatically generating documentation for a computing interface in accordance with some embodiments of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

As described herein, a computing system or platform may include one or more hosts, operating systems, peripherals, and/or applications. Machines in a same computing system or environment may have shared memory or resources, may be associated with the same or different hardware platforms, and/or may be located in the same or different physical locations. Computing systems described herein may refer to a virtualized environment (such as a cloud environment) and/or a physical environment.

A web service can refer to a software system designed to support interoperable machine-to-machine interaction over a network, and may have a computing application program interface (API), which may be described in a machine-readable/-processable format that describes the expectations and functionality of a particular web service, to indicate to a client how to correctly interact with the service. Other systems may interact with the web service in the manner prescribed by its description using messages, which may be conveyed using Hypertext Transport Protocol (HTTP) and/or other web-related standards. The output of a web service may be provided in a format that is standardized or otherwise convenient for a client application. For example, the input and output of a web service may be provided in an Extensible Markup Language (XML) format. As such, web services can allow for interoperating between different software applications running on a variety of platforms and/or frameworks.

WADL (Web Application Description Language) and WSDL 2.0 (Web Services Description Language) HTTP binding extension are two examples of machine-processable descriptions of the interface to a Representational State Transfer (REST)-style web service. WADL is a machine-readable XML-based resource-centric description language, which can model the resources provided by a web service and the relationships therebetween. A WADL description typically includes a set of resource elements, which may define the inputs, requests, and responses of resources provided by a web service, such that a complicated application may be described as basic operations (PUT, GET, POST, or DELETE) on the resources that make up the application's state. WSDL 2.0 is a machine-readable XML-based interface-centric description language, which may be used to describe the type and/or structure of elements a web service. A WSDL description typically includes a set of interface definitions which may each include operation definitions, and define how the web service can be called, what parameters it may expect, and what data structures it may return. WADL and WSDL may thus be used to define computing interfaces to web service operation(s), and may be used by a developer to assist in the creation of client software to help ensure that accurate information is passed to the web service operation from the client and back from the web service operation to the client.

An owner of an API for a web-based application may endeavor to provide accurate and up-to-date documentation to developers, in order to encourage and ease development of software (for example, for mobile devices) that accesses the web-based application via the API. Some embodiments of the present disclosure arise from realization that, while the software or source code implementing the API may include embedded comments that can be used to generate the documentation, such comments are typically provided by a programmer, and thus, may include descriptions that are difficult to understand or otherwise less meaningful to a user or developer. Also, embedded comments in the source code may not be updated without altering the source code itself, which may be impractical and/or undesirable.

Accordingly, some embodiments of the present disclosure provide methods, systems, and computer program products that can automatically create or generate interactive documentation for a computing interface from a machine-readable description of the computing interface, such as a Web Application Description Language (WADL) or Web Services Description Language (WSDL) file (more generally referred to herein as an interface description file). In particular, the documentation can be generated from comments or other narrative information that is typically included in an interface description file, based on the particular type or format thereof. As the interface description file is typically generated by a product manager (rather than the API's programmer), it may include more accurate and/or thorough narrative information than the embedded comments in the API itself. The documentation may thereby be generated more accurately, and in some embodiments on-the-fly (e.g., dynamically), without requiring changes to the underlying source code. For example, should the interface description file be changed or updated based on changes to the web service/API, the output documentation file may be automatically re-generated to reflect the changes. This interactive documentation can be used by software developers and/or others to learn about and/or test the API, reducing the time and effort needed to develop client software that accesses the API and potentially encouraging development efforts.

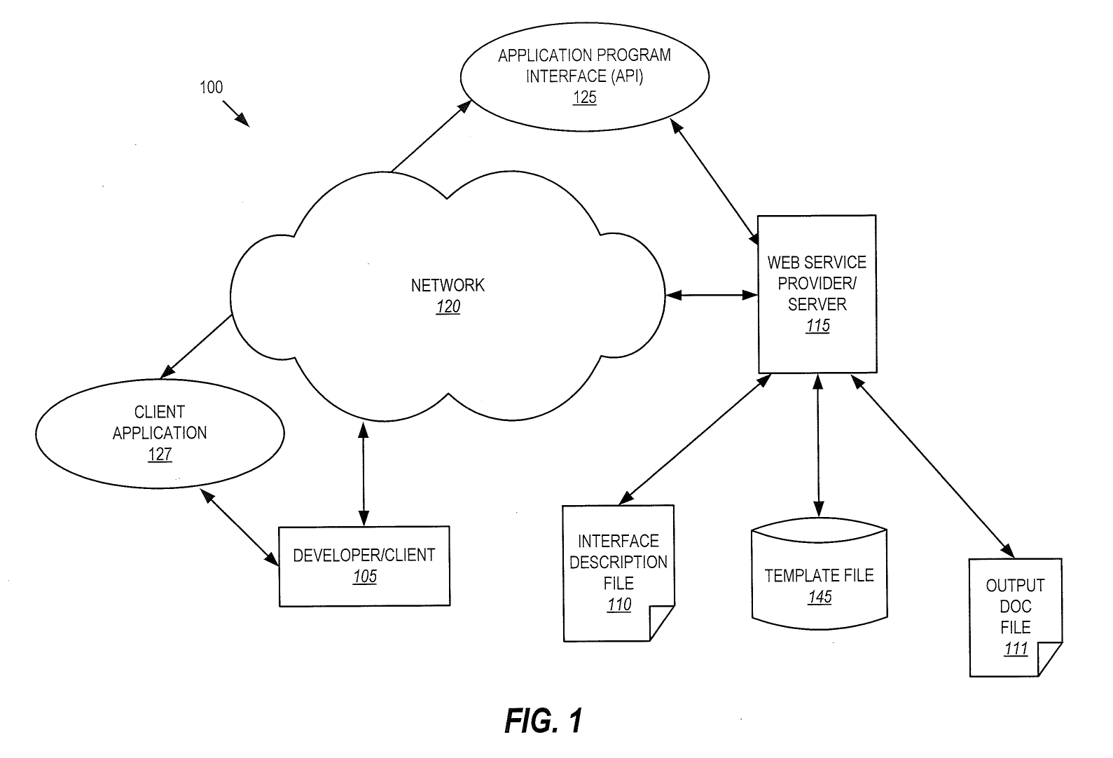

FIG. 1 illustrates a computing system or environment 100 for automatically generating narrative documentation for a computing interface in accordance with some embodiments of the present disclosure. Referring now to FIG. 1, the computing system 100 includes one or more client devices (illustrated as a developer device 105) that are coupled to one or more server devices (illustrated as a web service provider 115) via a network 120. A computing interface (illustrated as an application program interface (API) 125) for the web application provided by the server 115 is also accessible to a client application 127 via the network 120. The client application 127 may be created by or otherwise associated with the developer 105. In some embodiments, the server 115 may provide a developer portal through which the developer 105 can discover and/or test the functionality of the API 125 (and/or other available APIs) via the network 120, to encourage and ease development of the client application 127 or other client applications.

The network 120 may be a global network, such as the Internet, or other publicly accessible network. Various elements of the network 120 may be interconnected by a wide area network, a local area network, an Intranet, and/or other private network, which may not be accessible by the general public. Thus, the communication network 120 may represent a combination of public and private networks or a virtual private network (VPN). The network 120 may be a wireless network, a wireline network, or may be a combination of both wireless and wireline networks.

The client 105 and server 115 can communicate via the network 120 using a standard communications mode or architecture, such as Hypertext Transport Protocol (HTTP), Simple Object Access Protocol (SOAP), and/or Representational State Transfer (REST). Such architectures utilize a request-response communications model, where requests for service are sent from the client 105 to the server 115 (e.g., via the client application 127 and the API 125), and responses are sent from the server 115 to the client 105 (e.g., via the API 125 and the client application 127) in response to requests. In embodiments using a REST architecture, requests and responses are built around the transfer of representations of resources (e.g., documents that capture the current or intended states of resources). It will be appreciated that, in accordance with various embodiments of the present disclosure, the web service provider 115 may be implemented as a single server, separate servers, or a network of servers either co-located in a server farm, for example, or located in different geographic regions. In general, the client/server environment maintains a distinction between client and server processes, although client and server processes may operate on different machines or on the same machine.

The system 100 further includes an interface description file 110 (such as a WADL or WSDL file) for the API 125, as well as a database storing at least one template file 145, which are accessible to the client 105 via the network 120. The interface description file 110 may be generated by the service provider, and may include machine-readable data describing the API 125 for the service or application provided by the server 115, including how the API 125 can be called, expected parameters to be received by the API 125, and data structures to be returned from the API 125. For example, a WADL interface description file 110 may include a set of resource elements, each of which may contain ‘param’ elements to describe the inputs, and ‘method’ elements to describe the requests and responses of a resource.

A WADL or other machine-readable interface description file 110 as described herein may define markup and content, which may be distinguished by the application of simple syntactic rules. For example, character strings that constitute markup may begin with the character “<” and end with a “>”, or may begin with the character “&” and end with a “;”. A tag may refer to a markup construct that begins with <and ends with >. An attribute may refer to a markup construct consisting of a name/value pair that exists within a start-tag or empty-element tag. Strings of characters that are not markup may be referred to as content. An element may refer to a logical document component which either begins with a start-tag and ends with a matching end-tag or consists only of an empty-element tag. The characters between the start- and end-tags may be referred to as the element's content, and may contain markup, including other elements, which may be referred to as child elements. As such, machine readable information as described herein may include markup characters, while human readable information as described herein may be free of markup characters.

Still referring to the system 100 of FIG. 1, the stored template file 145 may include a machine-readable description identifying particular elements (of a file type or format corresponding to that of the interface description file 110) as being relevant to documentation for an associated computing interface (also referred to herein as being narratively relevant). The template file 145 may further define the correlation and/or transformation of the content of such elements in order to generate human-readable documentation having desired information and/or formatting therefrom. For example, the template file 145 may be an XML file that describes how elements, attributes, and/or values of a typical WADL file are to be converted to provide human-readable documentation for the API 125 corresponding to the interface description file 110. In particular, the template file 145 defines respective variables as corresponding to particular elements whose contents include human-readable narrative information based on the file type/format thereof, where the interface description file 110 is of the same file type/format (and thus includes the particular elements indicated in the template file 145). In some embodiments, multiple template files 145 may be stored for use in generating documentation including different information and/or formatting from a same interface description file 110. The template(s) 145 may be created or editable by the developer/client 105, by the web service provider/server 115, and/or by one or more other network devices in the system 100.

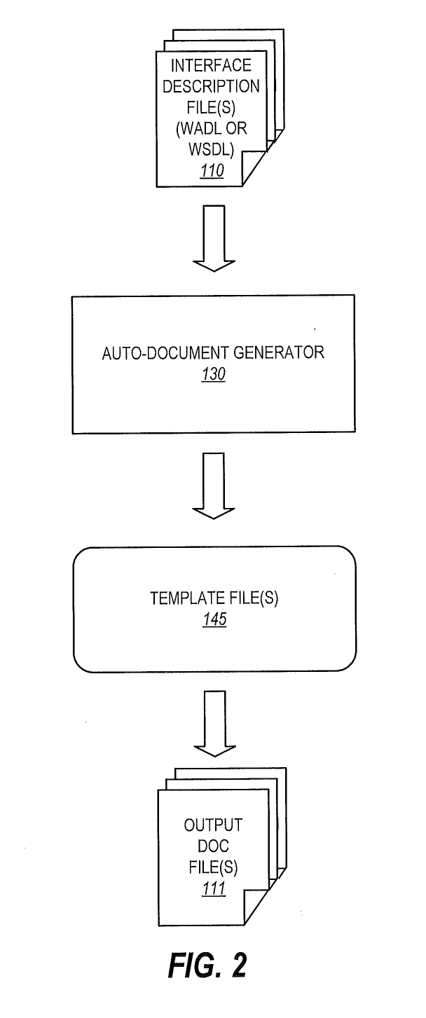

In embodiments of the present disclosure, the web service provider 115 (or other network entity) may utilize the machine-readable interface description file 110 to automatically generate an output file 111 including human readable documentation for the API 125, based on one or more of the stored template files 145. Operations of the system 100 of FIG. 1 will now be described with reference to the block diagram of FIG. 2. In operation, a machine-readable interface description file 110 (such as a WADL and/or WSDL file) is parsed by an auto-document generator module 130. The auto-document generator module 130 may be implemented by hardware and software included in the server 115 or other entity to which the interface description file 110 is accessible via the network 120. One or more elements of the interface description file 110 are identified as being relevant to documentation for the API 125 according to at least one of the template files 145 responsive to the parsing. For example, the WADL format may specify that contents of particular elements are to include narrative information about an associated computing interface as attribute values, and a template file 145 may ‘map’ these elements to respective variables defined in the template file 145 such that corresponding elements of the interface description file 110 can be identified.

Still referring to FIGS. 1 and 2, an output documentation file 111 including human-readable documentation for the API 125 is thereby automatically generated from the elements identified in the interface description file 110. In particular, the contents of the identified elements of the interface description file 110 may be correlated to the respective variables defined in the template file 145, the narrative information included as attribute values in the contents of these identified elements may be formatted and/or converted as specified in the template file 145, and the respective variables of the template file 145 may be replaced with the narrative information of the attribute values correlated thereto to generate the output documentation file 111. The template 145 may thereby be ‘merged’ with the identified elements of the parsed file 110 to generate an HTML (or other) output documentation file 111 including the narrative information in a human-readable format. The automatically generated output file 111 may thereby include more meaningful information with regard to the API 125 and/or service(s) provided by the web service provider 115, and may be provided to the developer 105 via the network 120 to ease development efforts. Also, in some embodiments, the output documentation file 111 may be generated to include one or more executable calls to the interface description file 110, which can be executed responsive to changes to the interface description file 110 to automatically update the output documentation file 111.

In the following example, the auto-document generator module 130 is implemented in accordance with Layer 7 (that is, the Application Layer) of the Open Systems Interconnection (OSI) Model to generate an output file 111 from the following example templates 145:
l7autodocs-template-full.xml—produces the actual documentation (as seen on a Portal) based on an input WADL file 110. This template may use some of the JavaScript and CSS from the Portal, which may be included in the lib folder.
l7autodocs-template.xml—is similar to l7-template-full.xml, but without the references to the CSS and scripts, effectively including the main body only.
validation-template.xml—produces a tree like doc (using <ul> and <li> tags) based on the input WADL file 110. This template may be used to test if the generator 130 can pick up all required data.

The following example WADL file may be input to the auto-document generator module 130 to generate the output file 111:
EchoService-autodoc-sample.wadl—used to generate an autodoc sample that may ship with the Portal. This WADL file can be relatively simple, and may generate two methods: GET and POST.

Accordingly, a command line:

java-jar layer7-autodocutil.jar<filename.wadl> <template.xml> input to the auto-document generator 130 will generate an output file 111 named “<filename.wadl>-output.html” on the same directory. This may be tested with the example template files 145 defined above, namely: l7autodocs-template.xml and l7autodocs-template-full.xml. The template files 145 may also be edited to match an environment.

Although FIGS. 1 and 2 illustrate example systems for automatically generating human-readable documentation for a computing interface, it will be understood that embodiments of the present disclosure are not limited to such configurations, but are intended to encompass any configuration capable of carrying out the operations described herein.

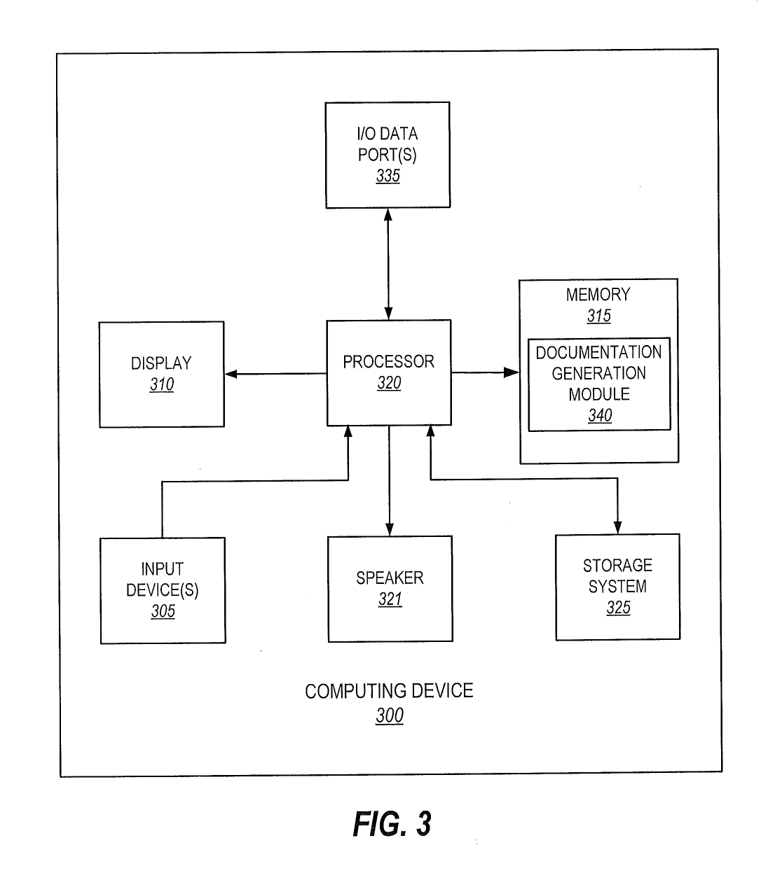

FIG. 3 illustrates an example computing device 200 including a documentation generation module 340 for automatically generating human-readable documentation for a computing interface in accordance with some embodiments of the present disclosure. The device 300 may be used, for example, to implement one or more of the client(s) 105 and the server(s) 115 in the system 100 of FIG. 1 using hardware, software implemented with hardware, firmware, tangible computer-readable storage media having instructions stored thereon, or a combination thereof, and may be implemented in one or more computer systems or other processing systems. The computing device 300 may also be a virtualized instance of a computer. As such, the devices and methods described herein may be embodied in any combination of hardware and software.

As shown in FIG. 3, the computing device 300 includes input device(s) 305, such as a keyboard or keypad, a display 310, and a memory 315 that communicate with one or more processors 320. The computing device 300 may further include a storage system 325, a speaker 321, and an I/O data port(s) 335 that also communicate with the processor 320. The memory 315 may be configured with a document generation module 340 that may parse an input file including a machine-readable description of a computing interface to identify one or more elements therein based on a stored template file, and automatically generate an output file including human-readable narrative information describing the computing interface as discussed in detail herein.

The storage system 325 may include removable and/or fixed non-volatile memory devices (such as but not limited to a hard disk drive, flash memory, and/or like devices that may store computer program instructions and data on computer-readable media), volatile memory devices (such as but not limited to random access memory), as well as virtual storage (such as but not limited to a RAM disk). While illustrated as separate elements, the memory 315 and the storage system 325 may be implemented in a same memory device in some embodiments. The input/output (I/O) data port(s) 335 may include a communication interface and may be used to transfer information in the form of signals between the computing device 300 and another computer system or a network (e.g., the Internet). The communication interface may include a modem, a network interface (such as an Ethernet card), a communications port, a PCMCIA slot and card, or the like. These components may be conventional components, such as those used in many conventional computing devices, and their functionality, with respect to conventional operations, is generally known to those skilled in the art. Communication infrastructure between the components of FIG. 3 may include one or more device interconnection buses such as Ethernet, Peripheral Component Interconnect (PCI), and the like.

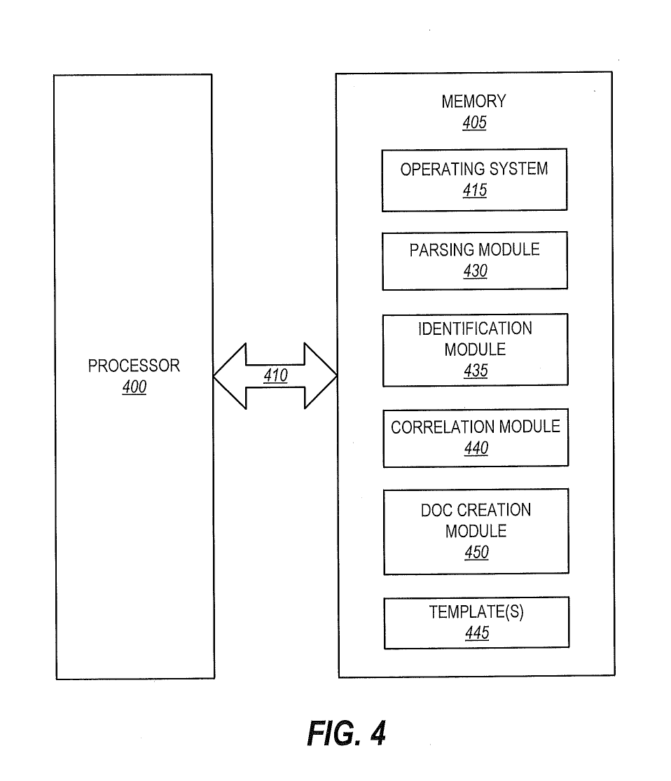

FIG. 4 illustrates a processor 400 and memory 405 that may be used in computing devices or other data processing systems, such as the computing device 300 of FIG. 3, for automatically generating documentation for a computing interface in accordance with some embodiments of the present disclosure. The processor 400 communicates with the memory 405 via an address/data bus 410. The processor 400 may be, for example, a commercially available or custom microprocessor, including, but not limited to, digital signal processor (DSP), field programmable gate array (FPGA), application specific integrated circuit (ASIC), and multi-core processors. The memory 405 is representative of the one or more memory devices containing the software and data used to automatically generate documentation for a computing interface in accordance with some embodiments of the present disclosure. The memory 405 may include, but is not limited to, the following types of devices: cache, ROM, PROM, EPROM, EEPROM, flash, SRAM, and DRAM.

As shown in FIG. 4, the memory 405 may contain multiple categories of software and/or data, including: an operating system 415, a parsing module 430, an identification module 335, a correlation module 440, a data structure storing template files 445, and a document creation module 450. The operating system 415 generally controls the operation of the computing device or data processing system. In particular, the operating system 415 may manage software and/or hardware resources and may coordinate execution of programs by the processor 400.

In some embodiments of the present disclosure, the parsing module 430 is configured to parse or analyze information in a WADL file (or other machine-readable description of a computing interface), and the identification module 435 is configured to identify one or more elements of the parsed WADL file that are relevant to generation of documentation for its associated computing interface according to the information included in a template file 445. In particular, one or more of the template files 445 may indicate that contents of particular elements of a WADL file-type include human-readable narrative information about an associated computing interface, and the identification module 435 may identify these elements in the parsed WADL file based on the template file 445. The correlation module 440 is configured to correlate the contents of the identified elements with respective variables defined by the template file 445. The document creation module 450 is configured to create an output file that includes the contents of the parsed WADL file based on the correlation with the variables of the template file 445. For instance, the contents may be converted and/or formatted in some embodiments in accordance with the variables defined in the template file 445, and the template file 445 may be populated with the converted/formatted contents of the parsed WADL file (for example, by replacing the variables in the template file 445 with the contents of the elements of the WADL file that were correlated thereto). The output documentation file is thereby automatically generated to include human-readable documentation about a computing interface/API from the elements identified in the machine-readable description of the parsed WADL file.

Although FIG. 4 illustrates exemplary hardware/software architectures that may be used in data processing systems, such as the computing device 300 of FIG. 3, for automatically generating documentation for a computing interface, it will be understood that the present disclosure is not limited to such a configuration but is intended to encompass any configuration capable of carrying out operations described herein. Moreover, the functionality of the computing device 300 of FIG. 3 and the hardware/software architecture of FIG. 4 may be implemented as a single processor system, a multi-processor system, a processing system with one or more cores, a distributed processing system, or even a network of stand-alone computer systems, in accordance with various embodiments.

Computer program code for carrying out the operations discussed above with respect to FIG. 4 may be written in a high-level programming language, such as COBOL, Python, Java, C, and/or C++, for development convenience. In addition, computer program code for carrying out operations of the present disclosure may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

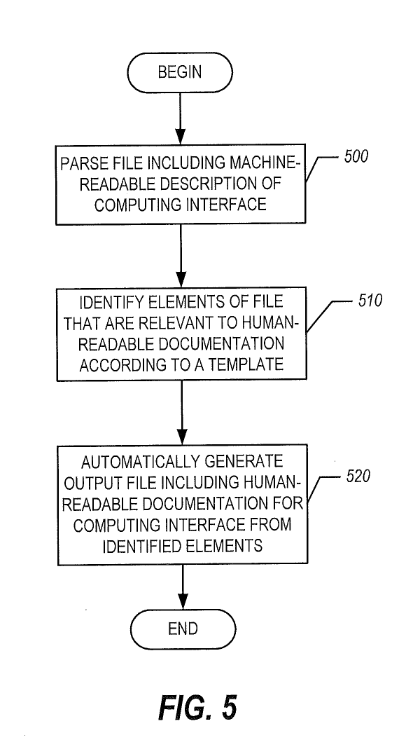

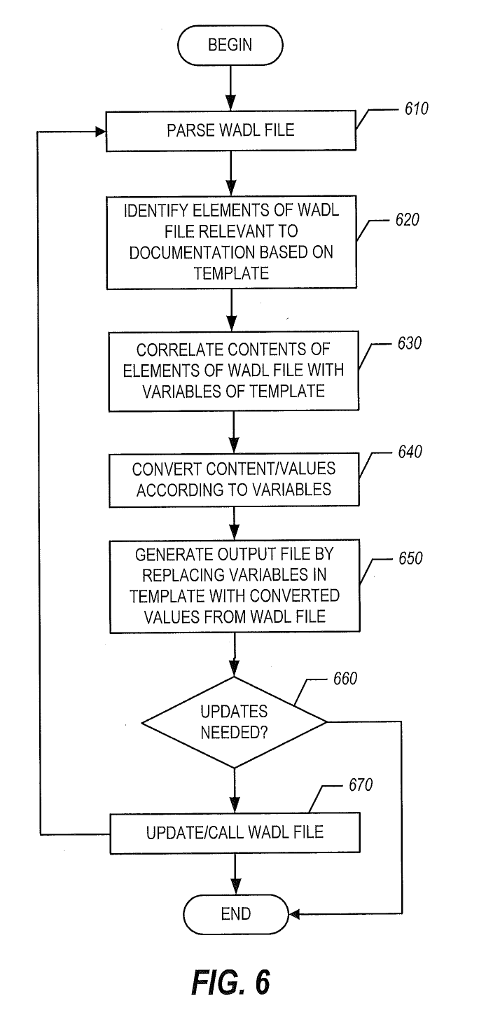

Operations for automatically generating documentation for a computing interface in accordance with some embodiments of the present disclosure will now be described with reference to the flowcharts of FIGS. 5 to 6. The operations described with reference to FIGS. 5 and 6 may be performed by the hardware/software architecture of FIG. 4, the computing device 300 of FIG. 3, the server 115 and/or the client 105 of FIG. 1, and/or elements thereof. Referring now to FIG. 5, operations begin at block 500 where an interface description file is parsed. The interface description file includes a machine-readable description of a web application interface (such as a WADL file) or other computing interface. In some embodiments, the interface description file may have an XML-type structure, such that elements of the file include markup and content information.

One or more elements of the interface description file are identified according to a template file at block 510. The template file may include a machine-readable description identifying one or more elements of a particular file type or format (common to the interface description file) as being narratively relevant to generation of human-readable documentation for an associated computing interface. For example, the template file may include blocks defining respective variables as corresponding to particular elements of a WADL file whose contents can be used to generate documentation. In some embodiments, the contents of the identified elements of the WADL file may include character strings representing narrative information in a human readable format. The narrative information may further describe an associated computing interface/API and/or application, for example, in terms of functionality or purpose, which may allow developers to more easily create software applications to access the application via the API. In some embodiments, the narrative information may be provided as values of respective attributes of the elements that are identified by the template file. For example, a WADL file may have a standardized format whereby values of one or more attributes of particular elements include human-readable comments or other information describing the computing interface. The elements may be identified based on a type, markup, content, and/or other property thereof specified by the template. The template file may also define any desired conversion or formatting of the contents of the identified elements for inclusion in the output documentation file. The template file may thereby indicate (i) the particular elements of the interface description file that include information relevant to documentation for the computing interface (or are otherwise relevant to documentation generation), and (ii) the conversion and/or formatting of the information in the documentation. The template file may be user-generated or user-editable in some embodiments.

At block 520, an output file including human-readable documentation for the computing interface is automatically generated from the elements that were identified in the interface description file at block 510. For example, in a WADL file, the contents of the particular elements (which were identified by the template file as including human-readable narrative information) may be correlated to the respective variables as specified in the template file, and the output file may be created by replacing, appending, or otherwise populating the respective variables of the template file with the human-readable narrative information of the elements correlated thereto. As such, the output file may be populated with human-readable documentation, while retaining the type, order, or structure defined by the template file. The identified elements of the parsed interface description file are thus ‘merged’ with the template file to automatically generate an output file (such as an HTML file) including documentation for the computing interface, which provides additional narrative information describing the computing interface and/or the associated web application that may be understood by a developer or other user, which may ease development of client applications for the computing interface.

FIG. 6 is a flowchart illustrating operations for automatically generating documentation for a computing interface in accordance with some embodiments of the present disclosure in greater detail. Referring now to FIG. 6, a WADL file (or other machine-readable file describing a computing interface) is parsed at block 610. At block 620, elements of the WADL are identified as being relevant to documentation for the computing interface based on a template file. For example, the template file may indicate that particular elements of a standard WADL file contain human-readable narrative information that may be used to generate documentation for the computing interface, and the elements of the WADL file that was parsed at block 610 may be identified based on the indications in the template file. Contents of the identified elements of the parsed WADL file are correlated with respective variables of the template file at block 630. For example, the template file may include blocks defining the respective variables as corresponding to attributes values of particular elements of a file having a WADL type or format, and the contents of the identified elements of the parsed WADL file may be correlated to the respective variables based on the template file.

At block 640, the values of the respective attributes of the elements of the parsed WADL file are converted or otherwise formatted in accordance with the variables of the template file. In some embodiments, variables in the template that define similarly named resource paths may be grouped prior to transforming or converting the values of correlated thereto. An output file is automatically generated by replacing, appending, or otherwise populating the variables in the template with the converted values from the WADL file at block 650. In particular, the variables of the template file may be replaced with the human-readable narrative information included as attribute values of the identified elements of the WADL file, effectively ‘merging’ the contents of the identified elements with the template file to generate the output file. As such, the output file includes human-readable documentation based on the narrative information extracted from the machine-readable WADL file.

In some embodiments, the generated output file generated at block 650 may not be static, but rather, may be ‘interactive’ or dynamically updated. In particular, at block 660, it is determined whether updates to the WADL file and/or output file are needed, for example, based on changes to the associated web service/API. If updates are needed, one or more elements of the WADL file are altered or updated at block 670, and operations 610-650 are repeated to regenerate the documentation for the output file based on the changes to the WADL file. Additionally or alternatively, the output file may include an executable call to the WADL file, and the call may be executed at block 670 if it is determined that updates are needed at block 660. As such the human readable documentation of the output file may be tied to a ‘live’ API, and may thereby be dynamically updated without altering the source code of the API.

A Layer 7 implementation of a template file in accordance with embodiments of the present disclosure is described below with reference to the following examples. An auto doc generation module (such as the module 130 of FIG. 2) may use a Layer 7-defined template to perform the transformation of a WADL file into human-readable documentation for its corresponding API. The template may be an XML file that describes how the WADL elements and/or attributes are to be converted to generate the documentation. As such, after a WADL file has been parsed, its values are converted according to variables in the template file, and the variables in the template file can be replaced with the converted values.

An example structure of a template file (defining the particular blocks specified below) may include:

<L7:docTemplate xmlns:L7=“http://ns.l7tech.com/2012/10/autodoc”>
<L7:template></L7:template>
<L7:header></L7:header>
<L7:resources></L7:resources>
<L7:resource></L7:resource>
<L7:method></L7:method>
<L7:param></L7:param>
<L7:param_option></L7:param_option>
<L7:param_option_value></L7:param_option_value>
<L7:request></L7:request>
<L7:request_representation></L7:request_representation>
<L7:request_representation_value></L7:request_representation_value>
<L7:response></L7:response>
<L7:response_representation></L7:response_representation>
<L7:footer></L7:footer>
<L7:settings></L7:settings>
</L7:docTemplate>

The <template> block may define the appearance of the output file:

<L7:template>
<![CDATA[
{{HEADER}}
{{RESOURCES_DATA}}
{{FOOTER}}
]]>
</L7:template>

The available variables that can be used for the <template> block may include:

| Entity | Description | Notes |
|---|---|---|
| {{HEADER}} | the generated content on | |
| | the <header> block | |
| {{RESOURCES_DATA}} | the generated content | accumulated |
| | based on the <resources> | <resources>'s |
| | block | |
| {{FOOTER}} | the generated content on | |
| | the <header> block | |

The <header> block may define what goes into the header. This block may not include variables, and may instead define common header/data content:

<L7:header>
<![CDATA[
<html>
<body>
]]>
</L7:header>

The <footer> block may define what goes into the footer. This block may not include variables, and may instead define common footer/data content:

<L7:footer>
<![CDATA[
</body>
</html>
]]>
</L7:footer>

The <settings> block may allow users to configure transformation settings, and in some embodiment may support groupMode settings only. Setting groupMode settings to true will tell the WADL parser to group similarly named resource paths before value transformation or conversion begins. This block may also not include variables, but rather, defines the settings:

<L7:settings> groupMode:true
</L7:settings

The <resources> block may define the transformation for each resources in the WADL. This is then accumulated and then assigned to the variable {{RESOURCES_DATA}} that the <template> block can use:

<L7:resources>
<![CDATA[
<ul>
<li><p>base:{{RESOURCES_BASE}}</p></li>
<li>index:{{RESOURCES_INDEX}}</li>
<li>doc_title:{{RESOURCES_DOC_TITLE}}</li>
<li>doc_data:{{RESOURCES_DOC_DATA}}</li>
<ul>
{{RESOURCE_DATA}}
</ul>
</ul>
]]>
</L7:resources>

A sample WADL file includes:

<wadl:resources base=“http://enoki-ssg62.l7tech.com/portalman/”>
<wadl:resources base=“http://enoki-ssg62.l7tech.com/portalman/”>
<wadl:doc title=“this is a title”>
this is a data
</wadl:doc>
...
</wadl:resources>
...

The available variables that can be used for the <resources> block include:

| Entity | Description | Notes |
|---|---|---|
| {{RESOURCES_BASE}} | the base defined in | |
| | the WADL resources | |
| {{RESOURCES_INDEX}} | the index this resources | |
| | appear in the WADL | |
| {{RESOURCES_DOC_TITL | the data in the doc | |
| | title attribute | |
| {{RESOURCES_DOC_DATA | the data in between | |
| | <doc> tag | |
| {{RESOURCE_DATA}} | the generated content | accumulated |
| | based on the <resource> | <resource>'s |
| | block | |

The <resource> block may define the transformation for each resource in the WADL, which are accumulated and assigned to the variable {{RESOURCE_DATA}} that the <resources> block can use:

<L7:resource>
<![CDATA[
<ul>
<li>path:{{RESOURCE_PATH}}</li>
<li>index:{{RESOURCE_INDEX}},root:{{RESOURCES_INDEX}}</li>
<li>id:{{RESOURCE_ID}}</li>
<li>doc_title:{{RESOURCE_DOC_TITLE}}</li>
<li>doc_data:{{RESOURCE_DOC_DATA}}</li>
<ul>
{{METHOD_DATA}}
</ul>
</ul>
]]>
</L7:resource>

A sample WADL file includes:

<wadl:resources base=“...”>
<wadl:resource paths=“/Service1.asmx” id=“ACME Warehouse”>
<wadl:doc title=“this is a title”>
this is a data
</wadl:doc>

</wadl:resource>

...
</wadl:resources>

The available variables that can be used for the <resource> block include:

| Entity | Description | Notes |
|---|---|---|
| {{RESOURCE_PATH}} | the path defined in | |
| | the WADL resource | |
| {{RESOURCE_ID}} | the id defined in | if empty, |
| | the WADL resource | defaults to |
| | | the path |
| {{RESOURCE_INDEX}} | the index this resource | |
| | appear in the WADL | |
| | file | |
| {{RESOURCES_INDEX}} | the index of the top | |
| | resources this resource is | |
| | associated with | |
| {{RESOURCE_DOC_TITL | the data in the doc | |
| | title attribute | |
| {{RESOURCE_DOC_DATA | the data in between | |
| | <doc> tag | |
| {{METHOD_DATA}} | the generated content | accumulated |
| | based on the <method> | <method>'s |
| | block | |

The <method> block may define the transformation for each method in the WADL, which are accumulated and then assigned to the variable {{METHOD_DATA}} that the <resource> block can use:

<L7:method>
<![CDATA[
<ul>
<li>name:{{METHOD_NAME}},real operation:{{METHOD_OPERATION}}</li>
<li>index:{{METHOD_INDEX}},root:{{RESOURCE_INDEX}},{{RESOURCES_I
NDEX}}</li>
<li>id:{{METHOD_ID}}</li>
<li>doc_title:{{METHOD_DOC_TITLE}}</li>
<li>doc_data:{{METHOD_DOC_DATA}}</li>
<ul>
{{PARAM_DATA}}
</ul>
<ul>
{{REQUEST_DATA}}
</ul>
<ul>
{{RESPONSE_DATA}}
</ul>
</ul>
]]>
</L7:method>

A sample WADL file includes:

<wadl:resources base=“...”>
<wadl:resource path=“...” id=“...”>
<wad:method name=“GET” id=“listProducts”>
<wadl:doc title=“this is a title”> this is a data
</wadl:doc>
</wadl:method>
...
</wadl:resource>
</wadl:resources>

The available variables that can be used for the <method> block include:

| Entity | Description | Notes |
|---|---|---|
| {{METHOD_NAME}} | the path defined in the | |
| | WADL resource | |
| {{METHOD_ID}} | the id defined in the WADL | if empty, defaults to the name |
| | resource | |
| {{METHOD_OPERATION}} | the real method operation | If no valid operation is found, defaults to |
| | in lowercase | get. Useful for defining fixed style for |
| | | specific operation. |
| {{METHOD_INDEX}} | the index this resource | |
| | appear in the WADL file | |
| {{METHOD_DOC_TITLE}} | the data in the doc title | if empty, copies doc_data, if it's more |
| | attribute | than 100 characters, copies up to the |
| | | first occurrence of period (.) or first |
| | | occurrence of space after the 100 |
| | | character cut-off |
| {{METHOD_DOC_DATA}} | the data in between <doc> | |
| | tag | |
| {{RESOURCE_PATH}} | the resource path for this | |
| | method | |
| {{RESOURCE_INDEX}} | the index of the top | |
| | resource this method is | |
| | associated with | |
| {{RESOURCES_INDEX}} | the index of the top | |
| | resources the resource of | |
| | the method is associated | |
| | with | |
| {{PARAM_DATA}} | the generated content | accumulated <param>'s & |
| | based on the <param> & | <par am_option>'s |
| | <param_option> block | |
| {{REQUEST_DATA}} | the generated content | |
| | based on the <request> | |
| {{RESPONSE_DATA}} | the generated content | |
| | based on the <response> | |
| {{METHOD_PATH}} | the resource path for this | this is layer7 specific, at parsing, we |
| | method | copy the resource path to the method |
| | | level, just in case we wanted to |
| | | support SWAGGER groupings |

The <param> block may define the transformation for each param in the WADL, which are accumulated and then assigned to the variable {{PARAMDATA}} that the <method> block can use:

<L7:param>
<![CDATA[
<li>name:{{PARAM_NAME}}</li>
<li>index:{{PARAM_INDEX}},root:{{METHOD_INDEX}},{{RESOURCE_INDE
X}},{{RESOURCES_INDEX}}</li>
<ul>
<li>isOption:{{PARAM_ISOPTION}}</li>
<li>type:{{PARAM_TYPE}}</li>
<li>required:{{PARAM_REQUIRED}}</li>
<li>default:{{PARAM_DEFAULT}}</li>
<li>style:{{PARAM_STYLE}}</li>
<li>doc_title:{{PARAM_DOC_TITLE}}</li>
<li>doc_data:{{PARAM_DOC_DATA}}</li>
</ul>
]]>
</L7:param>

A sample WADL file includes:

<wadl:resources base=“...”>
<wadl:resource path=“...” id=“...”>
<wad:method name=“...” id=“...”>
<wadl:param name=“name” type=“xs:string” required=“true” default=“”
style=“query”>
<wadl:doc title=“this is a title”> this is a data
</wadl:doc>
</wadl:param>
</wadl:method>
...
</wadl:resource>
</wadl:resources>

The available variables that can be used for the <param> block include:

| Entity | Description | Notes |
|---|---|---|
| {{PARAM_NAME}} | the path defined in the WADL | |
| {{PARAM_TYPE}} | the type defined in the WADL | |
| {{PARAM_REQUIRED}} | the required defined in the WADL | normally true |
| {{PARAM_REQUIRED_AS_TEXT}} | the exact text required | if PARAM_REQUIRED is |
| | | true |
| {{PARAM_DEFAULT}} | the default defined in the WADL | |
| {{PARAM_STYLE}} | the style defined in the WADL | |
| {{PARAM_ISOPTION}} | should be false in this case | l7 value that we make |
| | | available |
| {{PARAM_DOC_TITLE}} | the data in the doc title attribute | |
| {{PARAM_DOC_DATA}} | the data in between <doc> tag | |
| {{PARAM_INDEX}} | the index of this parameter | |
| {{METHOD_INDEX}} | the index of the top method | |
| {{RESOURCE_INDEX}} | the index of the top resource | |
| {{RESOURCES_INDEX}} | the index of the top resources | |

The <param_option> block may define the transformation for each param in the WADL, which is accumulated and then assigned to the variable {{PARAM_DATA}} that the <method> block can use. This block is for param that have options associated with it:

<L7:param>
<![CDATA[
<li>name:{{PARAM_NAME}}</li>
<li>index:{{PARAM_INDEX}},root:{{METHOD_INDEX}},{{RESOURCE_INDE
X}},{{RESOURCES_INDEX}}</li>
<ul>
<li>isOption:{{PARAM_ISOPTION}}</li>
<li>type:{{PARAM_TYPE}}</li>
<li>required:{{PARAM_REQUIRED}}</li>
<li>default:{{PARAM_DEFAULT}}</li>
<li>style:{{PARAM_STYLE}}</li>
<li>doc_title:{{PARAM_DOC_TITLE}}</li>
<li>doc_data:{{PARAM_DOC_DATA}}</li>
<ul>
{{PARAM_OPTIONS}}
</ul>
</ul>
]]>
</L7:param>

A sample WADL file includes:

<wadl:resources base=“...”>
<wadl:resource path=“...” id=“...”>
<wad:method name=“...” id=“...”>
<wadl:param name=“name” type=“xs:string” required=“true” default=“”
style=“query”>
<wadl:doc title=“this is a title”> this is a data
</wadl:doc>
<option value=“value1”/>
<option value=“value1”/>
<option value=“value2”>
</wadl:param>
</wadl:method>
...
</wadl:resource>
</wadl:resources>

The available variables that can be used for the <param_option> block include:

| Entity | Description | Notes |
|---|---|---|
| {{PARAM_NAME}} | the path defined in the WADL resource | |
| {{PARAM_TYPE}} | the type defined in the WADL resource | |
| {{PARAM_REQUIRED}} | the required defined in the WADL | normally true |
| {{PARAM_REQUIRED_AS_TEXT}} | the exact text required | if PARAM_REQUIRED |
| | | is true |
| {{PARAM_DEFAULT}} | the default defined in the WADL resource | |
| {{PARAM_STYLE}} | the style defined in the WADL resource | |
| {{PARAM_ISOPTION}} | should be true in this case | l7 value that we make |
| | | available |
| {{PARAM_DOC_TITLE}} | the data in the doc title attribute | |
| {{PARAM_DOC_DATA}} | the data in between <doc> tag | |
| {{PARAM_INDEX}} | the index of this parameter | |
| {{METHOD_INDEX}} | the index of the top method | |
| {{RESOURCE_INDEX}} | the index of the top resource | |
| {{RESOURCES_INDEX}} | the index of the top resources | |
| {{PARAM_OPTIONS}} | the generated content based on the | accumulated |
| | <param_option_value> block | <param_option_value>'s |

The <param_option_value> block may define the transformation for each option in the WADL, which is accumulated and then assigned to the variable {{PARAM_OPTIONS}} that the <param_option> block can use. This block is for param that have options associated with it:

<L7:param_option_value>
<![CDATA[
<li>value:{{OPTION_VALUE}}</li>
<li>mediaType:{{OPTION_MEDIA_TYPE}}</li>
<li>index:{{OPTION_INDEX}},root:{{PARAM_INDEX}},{{METHOD_INDEX}}
,{{RESOURCE_INDEX}},{{RESOURCES_INDEX}}</li>
]]>
</L7:param_option_value>

A sample WADL file includes:

<wadl:resources base=“...”>
<wadl:resource path=“...” id=“...”>
<wad:method name=“...” id=“...”>
<wadl:param name=“name” type=“xs:string” required=“true” default=“”
style=“query”>
<wadl:doc title=“this is a title”> this is a data
</wadl:doc>
<option value=“value1”/>
<option value=“value1”/>
<option value=“value2”/>
</wadl:param>
</wadl:method>
...
</wadl:resource>
</wadl:resources>

The available variables that can be used for the <param_option_value> block include:

| Entity | Description |
|---|---|
| {{OPTION_VALUE}} | the value defined in the WADL option |
| {{OPTION_MEDIA_TYPE}} | the mediaType defined in the WADL |
| {{OPTION_DOC_TITLE}} | the data in the doc title attribute |
| {{OPTION_DOC_DATA}} | the data in between <doc> tag |
| {{OPTION_INDEX}} | the index of this option |
| {{PARAM_INDEX}} | the index of the top parameter |
| {{METHOD_INDEX}} | the index of the top method |
| {{RESOURCE_INDEX}} | the index of the top resource |
| {{RESOURCES_INDEX}} | the index of the top resources |

The <request> block may define the transformation for each request in the WADL, which may be accumulated and then assigned to the variable {{REQUEST_DATA}} that the <method> block can use. The param under request can be automatically handled by the <param> block which may be processed at the method level. In some embodiments, REQUEST_DOC_TITLE & REQUEST_DOC_{—} DATA may only be available when there is representation in the request:

<L7:request>
<![CDATA[
<li>index:{{REQUEST_INDEX}},root:{{METHOD_INDEX}},{{RESOURCE_IN
DEX}},{{RESOURCES_INDEX}}</li>
<ul>
{{REPRESENTATION_DATA}}
</ul>
]]>
</L7:request>

A sample WADL file includes:

<wadl:resources base=“...”>
<wadl:resource path=“...” id=“...”>
<wad:method name=“...” id=“...”>
<wadl:request>
<param name=“SOAPAction” type=“xs:string” required=“true”
default=“http://warehouse.acme.com/ws/placeOrder” styl
<wadl:doc title=“this is a title”> this is a data
</wadl:doc>
...
</wadl:request>
</wadl:method>
</wadl:resource>
</wadl:resources>

The available variables that can be used for the <request> block include:

| Entity | Description | Notes |
|---|---|---|
| {{REQUEST_DOC_TITLE}} | the data in the doc title | |
| | attribute | |
| {{REQUEST_DOC_DATA}} | the data in between <doc> | |
| | tag | |
| {{REPRESENTATION_DATA}} | the generated content based | accumulated |
| | on the <request_representation> block | <request_representation>'s |
| {{REPRESENTATION_VALUE_DATA}} | the generated content based | accumulated |
| | on the <request_representation_value> block | <request_representation_value>'s |
| {{REPRESENTATION_DEFAULT_VALUE}} | special variable to hold the | was needed for the POC |
| | data/text element of the first | and seems to be useful |
| | WADL representation for | |
| | this request | |
| {{REQUEST_INDEX}} | the index of this request | |
| {{METHOD_INDEX}} | the index of the top method | |
| {{RESOURCE_INDEX}} | the index of the top resource | |
| {{RESOURCES_INDEX}} | the index of the top resources | |

The <request_representation> block may define the transformation for each representation under request in the WADL, which may be accumulated and then assigned to the variable {{REPRESENTATION_DATA}} that the <request> block can use.

<L7:request_representation>
<![CDATA[
<li>id:{{REPRESENTATION_ID}}</li>
<li>index:{{REPRESENTATION_INDEX}},root:{{METHOD_INDEX}},{{RESO
URCE_INDEX}},{{RESOURCES_INDEX}}</li>
<ul>
<li>mediaType:{{REPRESENTATION_MEDIA_TYPE}}</li>
<li>value:{{REPRESENTATION_VALUE}}</li>
</ul>
]]>
</L7:request_representation>

A sample WADL file includes:

<wadl:resources base=“...”>
<wadl:resource path=“...” id=“...”>
<wad:method name=“...” id=“...”>
<wadl:request>
...
<wadl:representation>
<wadl:doc title=“this is a title”> this is a data
</wadl:doc>
</wadl:representation>
...
</wadl:request>
</wadl:method>
</wadl:resource>
</wadl:resources>

Available variables that can be used for the <request_representation> block include:

| Entity | Description |
|---|---|
| {{REPRESENTATION_INDEX}} | the index of this |
| | representation |
| {{REPRESENTATION_DOC_TITLE}} | the data in the doc title |
| | attribute |
| {{REPRESENTATION_DOC_DATA}} | the data in between <doc> |
| {{REPRESENTATION_ID}} | the representation id |
| {{REPRESENTATION_MEDIA_TYPE}} | the representation |
| | mediaType |
| {{REQUEST_INDEX}} | the index of this request |
| {{METHOD_INDEX}} | the index of the top |
| | method |
| {{RESOURCE_INDEX}} | the index of the top |
| | resource |
| {{RESOURCES_INDEX}} | the index of the top |
| | resources |

The <request_representation_value> block may define the transformation for the text/data section of each representation under request in the WADL, which may be accumulated and then assigned to the variable {{REPRESENTATION_VALUE_DATA}} that the <request> block can use:

<L7:request_representation_value>
<![CDATA[
<li>id:{{REPRESENTATION_ID}}</li>
<li>index:{{REPRESENTATION_INDEX}},root:{{METHOD_INDEX}},{{RESO
URCE_INDEX}},{{RESOURCES_INDEX}}</li>
<ul>
<li>mediaType:{{REPRESENTATION_MEDIA_TYPE}}</li>
<li>value:{{REPRESENTATION_VALUE}}</li>
</ul>
]]>
</L7:request_representation_value>

A sample WADL file includes:

<wadl:resources base=“...”>
<wadl:resource path=“...” id=“...”>
<wad:method name=“...” id=“...”>
<wadl:request>
...
<wadl:representation id=“error” mediaType=“application/xml”>
<wadl:doc title=“this is a title”> this is a data
</wadl:doc>
<![CDATA
This is the data/text element for this representation
]]>
</wadl:representation>
...
</wadl:request>
</wadl:method>
</wadl:resource>
</wadl:resources>

The available variables that can be used for the <request_representation_value> block may include:

| Entity | Description | Notes |
|---|---|---|
| {{REPRESENTATION_INDEX}} | the index of this representation | |
| {{REPRESENTATION_VALUE}} | the text/data elements for this | |
| | representation | |
| {{REPRESENTATION_VALUE_FOR_SCRIPT}} | script friendly version for | no new |
| | REPRESENTATION_VALUE | line and |
| | | escaped |
| | | ‘ (single |
| | | quotes) |
| {{REQUEST_INDEX}} | the index of this request | |
| {{METHOD_INDEX}} | the index of the top method | |
| {{RESOURCE_INDEX}} | the index of the top resource | |
| {{RESOURCES_INDEX}} | the index of the top resources | |

The <response> block may define the transformation for each response in the WADL, which may be accumulated and then assigned to the variable {{RESPONSE_DATA}} that the <method> block can use:

<L7:response>
<![CDATA[
<li>index:{{RESPONSE_INDEX}},root:{{METHOD_INDEX}},{{RESOURCE_IN
DEX}},{{RESOURCES_INDEX}}</li>
<ul>
{{REPRESENTATION_DATA}}
</ul>
]]>
</L7:response>

A sample WADL file includes:

<wadl:resources base=“...”>
<wadl:resource path=“...” id=“...”>
<wad:method name=“...” id=“...”>
<wadl:response> <
<wadl:doc title=“this is a title”> this is a data
</wadl:doc>
...
</wadl:response>
</wadl:method>
</wadl:resource>
</wadl:resources>

The available variables that can be used for this <response> block may include:

| Entity | Description | Notes |
|---|---|---|
| {{RESPONSE_DOC_TITLE}} | the data in the doc title attribute | |
| {{RESPONSE_DOC_DATA}} | the data in between <doc> tag | |
| {{REPRESENTATION_DATA}} | the generated content based on the | accumulated <response_representation>'s |
| | <response_representation> block | |
| {{RESPONSE_INDEX}} | the index of this response | |
| {{METHOD_INDEX}} | the index of the top method | |
| {{RESOURCE_INDEX}} | the index of the top resource | |
| {{RESOURCES_INDEX}} | the index of the top resources | |

The <request_representation> block may define the transformation for each representation under response in the WADL. This is then accumulated and then assigned to the variable {{REPRESENTATION_DATA}} that the <response> block can use:

<L7:response_representation>
<![CDATA[
<li>id:{{REPRESENTATION_ID}}</li>
<li>index:{{REPRESENTATION_INDEX}},root:{{METHOD_INDEX}},{{RESO
URCE_INDEX}},{{RESOURCES_INDEX}}</li>
<ul>
<li>mediaType:{{REPRESENTATION_MEDIA_TYPE}}</li>
</ul>
]]>
</L7:response_representation>

A sample WADL file includes:

<wadl:resources base=“...”>
<wadl:resource path=“...” id=“...”>
<wad:method name=“...” id=“...”>
<wadl:response>
...
<wadl:representation status=“200” mediaType=“application/xml”>
<wadl:doc title=“this is a title”> this is a data
</wadl:doc>
</wadl:representation>
...
</wadl:response>
</wadl:method>
</wadl:resource>
</wadl:resources>

The available variables that can be used for the <request_representation> block may include:

| Entity | Description |
|---|---|
| {{REPRESENTATION_INDEX}} | the index of this |
| | representation |
| {{REPRESENTATION_DOC_TITLE}} | the data in the doc title |
| | attribute |
| {{REPRESENTATION_DOC_DATA}} | the data in between |
| | <doc> tag |
| {{REPRESENTATION_STATUS}} | the representation |
| | status |
| {{REPRESENTATION_MEDIA_TYPE}} | the representation |
| | mediaType |
| {{RESPONSE_INDEX}} | the index of this |
| | request |
| {{METHOD_INDEX}} | the index of the top |
| | method |
| {{RESOURCE_INDEX}} | the index of the top |
| | resource |
| {{RESOURCES_INDEX}} | the index of the top |
| | resources |

The flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of any means or step plus function elements in the claims below are intended to include any disclosed structure, material, or act for performing the function in combination with other claimed elements as specifically claimed.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method of generating documentation for a computing interface, the method comprising:
parsing an interface description file comprising a machine-readable description of a computing interface;
identifying elements of the interface description file according to a template file responsive to the parsing thereof; and
automatically generating an output file comprising human-readable documentation for the computing interface from the elements identified in the interface description file,
wherein the parsing, the identifying, and the automatically generating comprise operations performed by a processor.

2. The method of claim 1, wherein the template file comprises a machine-readable description indicating elements that are narratively relevant based on a file type thereof, and wherein the interface description file corresponds to the file type.

3. The method of claim 2, wherein the elements of the interface description file comprise content and markup information, and wherein automatically generating the output file comprises:
correlating the content information of the elements identified in the interface description file with respective variables of the template file; and
creating the output file to include the content information based on the correlating with the respective variables of the template file.

4. The method of claim 3, wherein the content information comprises values of respective attributes of the elements, and wherein creating the output file comprises:
converting the values of the respective attributes of the elements of the interface description file in accordance with the respective variables of template file responsive to the correlating; and
populating the respective variables of the template file with the values of the respective attributes correlated thereto responsive to the converting.

5. The method of claim 4, wherein the values comprise human readable narrative information.

6. The method of claim 1, further comprising:
updating the human-readable documentation of the output file without alteration of computer readable program code associated with the computing interface.

7. The method of claim 6, wherein the updating comprises:
altering one of the elements of the interface description file; and
repeating the parsing, the identifying, and the automatically generating to dynamically modify the human-readable documentation of the output file responsive to the altering.

8. The method of claim 6, wherein the output file comprises an executable call to the interface description file, and wherein the updating comprises:
executing the call to the interface description file responsive to alteration of one of the elements therein.

9. The method of claim 1, wherein the description of the computing interface comprises a set of resource descriptions, and wherein the interface description file comprises a web-application description language (WADL) file.

10. The method of claim 1, wherein the description of the computing interface comprises a set of interface definitions, and wherein the interface description file comprises a web-services description language (WSDL) file.

11. A computer system for generating documentation for a computing interface, comprising:
a processor; and
a memory coupled to the processor, the memory comprising computer readable program code embodied therein that, when executed by the processor, causes the processor to:
parse an interface description file comprising a machine-readable description of a computing interface;
identify elements of the interface description file according to a template file; and
automatically generate an output file comprising human-readable documentation for the computing interface from the elements identified in the interface description file.

12. The system of claim 11, wherein the template file comprises a machine-readable description indicating elements that are narratively relevant based on a file type thereof, and wherein the interface description file corresponds to the file type.

13. The system of claim 12, wherein, when executed by the processor to automatically generate the output file, the computer readable program code causes the processor to:
correlate the content information of the elements identified in the interface description file with respective variables of the template file; and
create the output file to include the content information based on the correlating with the respective variables of the template file.

14. The system of claim 13, wherein, when executed by the processor to create the output file, the computer readable program code causes the processor to:
convert the values of the respective attributes of the elements of the interface description file in accordance with the respective variables of template file responsive to the correlating; and
populate the respective variables of the template file with the values of the respective attributes correlated thereto responsive to the converting.

15. The system of claim 14, wherein the values comprise human-readable narrative information.

16. The system of claim 11, wherein, when executed by the processor, the computer readable program code further causes the processor to:
update the human-readable documentation of the output file without alteration of computer readable program code associated with the computing interface.

17. The system of claim 16, wherein, when executed by the processor to update the human-readable documentation, the computer readable program code causes the processor to:
alter one of the elements of the interface description file; and
repeat the parsing, the identifying, and the automatically generating to dynamically modify the human-readable documentation of the output file responsive to the altering.

18. The system of claim 16, wherein the output file comprises an executable call to the interface description file, and wherein, when executed by the processor to update the human-readable documentation, the computer readable program code causes the processor to:
execute the call to the interface description file responsive to alteration of one of the elements therein.

19. The system of claim 11, wherein the description of the computing interface comprises a set of resource descriptions, and wherein the interface description file comprises a web-application description language (WADL) file.

20. A computer program product for generating documentation for a computing interface, comprising:
a computer readable storage medium having computer readable program code embodied in the medium, the computer readable program code comprising:
computer readable program code to parse an interface description file comprising a machine-readable description of a computing interface;
computer readable program code to identify elements of the interface description file according to a template file; and
computer readable program code to automatically generate an output file comprising human-readable documentation for the computing interface from the elements identified in the interface description file.
